(19) United States
(12) Patent Application Publication
(10) Pub. No.: US 2018/0131946 A1
(43) Pub. Date: May 10, 2018

(54) CONVOLUTION NEURAL NETWORK SYSTEM AND METHOD FOR COMPRESSING SYNAPSE DATA OF CONVOLUTION NEURAL NETWORK

(71) Applicant: ELECTRONICS AND TELECOMMUNICATIONS RESEARCH INSTITUTE, Daejeon (KR)

(72) Inventors: Mi Young LEE, Daejeon (KR); Byung Jo KIM, Sejong (KR); Ju-Yeob KIM, Daejeon (KR); Jin Kyu KIM, Sejong (KR); Seong Min KIM, Sejong (KR); Joo Hyun LEE, Daejeon (KR)

(21) Appl. No.: 15/806,200

(22) Filed: Nov. 7, 2017

(30) Foreign Application Priority Data
Nov. 7, 2016 (KR) 10-2016-0147743
May 25, 2017 (KR) 10-2017-0064781

(51) Int. Cl. H04N 19/169; G06F 17/30; G06N 3/08; G06N 3/063; H04N 19/13; G06K 9/62

(52) U.S. Cl. CPC H04N 19/169; G06F 17/30244; G06K 9/6256; G06N 3/063; H04N 19/13; G06N 3/08

(57) ABSTRACT

Provided is a convolution neural network system including an image database configured to store first image data, a machine learning device configured to receive the first image data from the image database and generate synapse data of a convolution neural network including a plurality of layers for image identification based on the first image data, a synapse data compressor configured to compress the synapse data based on sparsity of the synapse data, and an image identification device configured to store the compressed synapse data and perform image identification on second image data without decompression of the compressed synapse data.

### CROSS-REFERENCE TO RELATED APPLICATIONS

This U.S. non-provisional patent application claims priority under 35 U.S.C. § 119 of Korean Patent Application Nos. 10-2016-147743, filed on Nov. 7, 2016, and 10-2017-0064781, filed on May 25, 2017, the entire contents of which are hereby incorporated by reference.

### BACKGROUND

The present disclosure herein relates to a convolution neural network system and a method for compressing synapse data of a convolution neural network.

Attempts for identifying objects in an image using a neural network have been made continuously. Convolution Neural Network (CNN) has a structure more suitable for identifying images among various neural networks. Accordingly, attempts for constructing a system for identifying images using the CNN have been made continuously.

The CNN includes a plurality of layers. Synapse data corresponding to the plurality of layers may be generated through machine learning using a plurality of images. The generated synapse data may be used to identify images. The CNN has a structure suitable for identifying images, but due to its structural features, the amount of synapse data is greater when compared to other neural networks.

### SUMMARY

The present disclosure provides a convolution neural network system and method for compressing synapse data of a convolution neural network.

An embodiment of the inventive concept provides a convolution neural network system including: an image database configured to store first image data; a machine learning device configured to receive the first image data from the image database and generate synapse data of a convolution neural network including a plurality of layers for image identification based on the first image data; a synapse data compressor configured to compress the synapse data based on sparsity of the synapse data; and an image identification device configured to store the compressed synapse data and perform image identification on second image data without decompression of the compressed synapse data.

In an embodiment, the synapse data compressor may vary a method of compressing synapse data corresponding to each layer according to a type of each of the plurality of layers of the convolution neural network.

In an embodiment, the synapse data compressor may select different compression methods, compress the synapse data using the different compression methods, and select a compressed synapse data group having a minimum capacity among compressed synapse data groups according to the different compression methods.

In an embodiment, the compression methods may include a method of compressing the synapse data as a non-zero value in the synapse data and indexes indicating a position of the non-zero value.

In an embodiment, the synapse data compressor may record each of the indexes as index bits, and divide an index exceeding a range displayed as the index bits into first index bits and second index bits and record the first and second index bits.

In an embodiment, the synapse data compressor may record the first index bits as a maximum value and record the second index bits as a remaining value obtained by subtracting a value obtained by adding 1 to the maximum value from the index.

In an embodiment, the synapse data compressor may record index bits of one or more indexes as one byte.

In an embodiment, when the index bits of the one or more indexes are smaller than the size of the one byte, the synapse data compressor may add one or more dummy bits to the index bits of the one or more indexes to record the index bits as the one byte.

In an embodiment, the compression methods may include a method of compressing the synapse data as the number (i.e., the first number) of non-zero values and zero values in the synapse data.

In an embodiment, the synapse data compressor may record the first number as the number (i.e., the second number) of zero and continuous zero values.

In an embodiment, the synapse data compressor may record the second number as index bits, and divide the second number exceeding a range displayed as the index bits into first index bits and second index bits and record the first and second index bits.

In an embodiment, the synapse data compressor may record zero and the first index bits and record zero and the second index bits, wherein the first index bits may have a maximum value and the second index bits may have a value obtained by subtracting a value obtained by adding 1 to the maximum value of the first index bits from the second number.

In an embodiment of the inventive concept, provided is a method of compressing synapse data of a convolution neural network. The method includes: selecting one compression method from compression methods; selecting the number of index bits; and performing compression of the synapse data according to the selected compression method and the selected number of index bits based on sparsity of the synapse data, wherein the index bits are a unit of a size of one index indicting information of one synapse of the synapse data.

In an embodiment, information recorded for each layer may vary according to a type of layers of the convolution neural network in the compressed synapse data.

In an embodiment, the compression methods may include a first method of compressing the synapse data as indexes indicating a non-zero value in the synapse data and indexes indicating a position of the non-zero value and a second method of compressing the synapse data as the number of zero values in the synapse data and a non-zero value.

In an embodiment, the method may further include selecting a compressed synapse data group having a smallest capacity among compressed synapse data groups according to different compression methods and the number of different index bits as compressed synapse data.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram showing a convolution neural network system according to an embodiment of the inventive concept;

FIG. 2 shows an example in which image data is processed by a plurality of layers of a convolution neural network;

FIG. 3 further shows an example in which image data is processed by a plurality of layers of a convolution neural network;

FIG. 4 is a table showing an example of the number of synapses of layers of a CNN described with reference to FIGS. 2 and 3;

FIG. 5 shows an example of a method of compressing synapse data according to an embodiment of the inventive concept;

FIG. 6 is a flowchart showing an example of compressing synapse data;

FIG. 7 is a flowchart showing an example of a method of compressing a convolution layer;

FIG. 8 is a flowchart showing an example of a method of compressing synapse data;

FIG. 9 is a flowchart showing an example of a method of compressing synapse data of a selected kernel;

FIG. 10 shows an example in which synapse data of synapses of second kernels is rearranged in order to explain the compression of the second kernels;

FIG. 11 shows an example of recording a one-dimensional matrix of FIG. 10 depending on a CSR method according to an embodiment of the inventive concept;

FIG. 12 shows an example of actually recording NZ values and relative sparse indexes of FIG. 11 with reference to index bits;

FIG. 13 is a flowchart showing an example of compressing synapse data according to a CSR method;

FIG. 14 shows examples in which the number of NZ values, the NZ values, and the relative sparse index are recorded in byte unit;

FIG. 15 shows an example of recording a one-dimensional matrix of FIG. 10 depending on a run length method according to an embodiment of the inventive concept;

FIG. 16 shows an example of actually recording the values of the run length of FIG. 15 with reference to index bits;

FIG. 17 is a flowchart showing an example of compressing synapse data according to a run length method;

FIG. 18 is a flowchart showing an example of a method of compressing a fully connected layer;

FIG. 19 is a flowchart showing an example of a method of compressing a sub-sampling layer;

FIG. 20 is a flowchart showing an example of a method of compressing an active layer;

FIG. 21 is a block diagram showing an example of an image identification device according to an embodiment of the inventive concept;

FIG. 22 is a flowchart showing an example of an operation method of an image processor of FIG. 21;

FIG. 23 is a block diagram showing a convolution neural network system according to an embodiment of the inventive concept; and

FIG. 24 is a block diagram showing an example of an image identification device of FIG. 23.

### DETAILED DESCRIPTION

In the following, embodiments of the inventive concept will be described in detail so that those skilled in the art easily carry out the inventive concept.

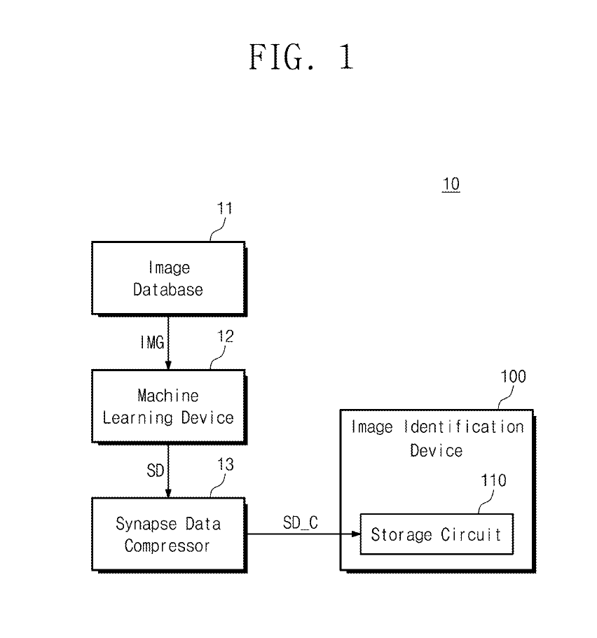

FIG. 1 is a block diagram showing a convolution neural network system 10 according to an embodiment of the inventive concept. Referring to FIG. 1, the convolution neural network system 10 includes an image database 11, a machine learning device 12, a synapse data compressor 13, and an image identification device 100.

The image database 11 may store a plurality of images IMG. The machine learning device 12 may perform machine learning using the images IMG stored in the image database 11. For example, the machine learning device 12 may perform machine learning to generate synapse data SD of a plurality of layers of a Convolution Neural Network (CNN).

The synapse data compressor 13 may compress the synapse data SD generated by the machine learning device 12. For example, the synapse data compressor 13 may compress synapse data SD based on its sparsity. The sparsity of the synapse data SD may mean that a non-zero value in the synapse data SD is sparse. The synapse data compressor 13 may generate compressed synapse data SD_C.

The image identification device 100 may include a storage circuit 110. The compressed synapse data SD_C may be stored in the storage circuit 110. For example, the compressed synapse data SD_C may be stored in the storage circuit 110 when the image identification device 110 is manufactured. As another example, the compressed synapse data SD_C may be stored in the storage circuit 110 through downloading of the application or through updating of the firmware after the image identification device 110 is manufactured. The image identification device 110 may identify an image using the compressed synapse data SD_C. For example, the compressed synapse data SD_C may be used to identify an image without decompression.

The machine learning device 12 may include an integrated circuit (IC), a field programmable gate array (FPGA), a complex programmable logic device (CPLD), an Application Specific Integrated Circuit (ASIC), circuit, device, a Graphic Processing Unit (GPU), and a Neuromorphic chip, and the like, which are configured to perform machine learning according to an embodiment of the inventive concept. The machine learning device 12 may include an IC, an FPGA, a CPLD, an ASIC, a circuit, a device, a GPU, a Neuromorphic chip, and the like, which drive firmware (or software) configured to perform machine learning according to an embodiment of the inventive concept.

The synapse data compressor 13 includes an IC, an FPGA, a CPLD, an ASIC, a circuit, a device, a GPU, a Neuromorphic chip, and the like, which are configured to compress synapse data according to an embodiment of the inventive concept. The machine learning device 12 may include an IC, an FPGA, a CPLD, an ASIC, a circuit, a device, a GPU, a Neuromorphic chip, and the like, which drive firmware (or software) configured to compress synapse data according to an embodiment of the inventive concept.

For example, the machine learning device 12 may be referred to as a convolution neural network device in that it generates the synapse data (SD) of the CNN. The synapse data compressor 13 may be referred to as a convolution neural network device in that it compresses the synapse data (SD) of the CNN to generate the compressed synapse data SD_C. The image identification device 100 may be referred to as a convolution neural network device in that it uses the compressed synapse data of the CNN to identify an image. The machine learning device 12 and the synapse data compressor 13 may form one convolution neural network device in that they generate the synapse data SD of the CNN and compress the synapse data SD to generate the compressed synapse data SD_C.

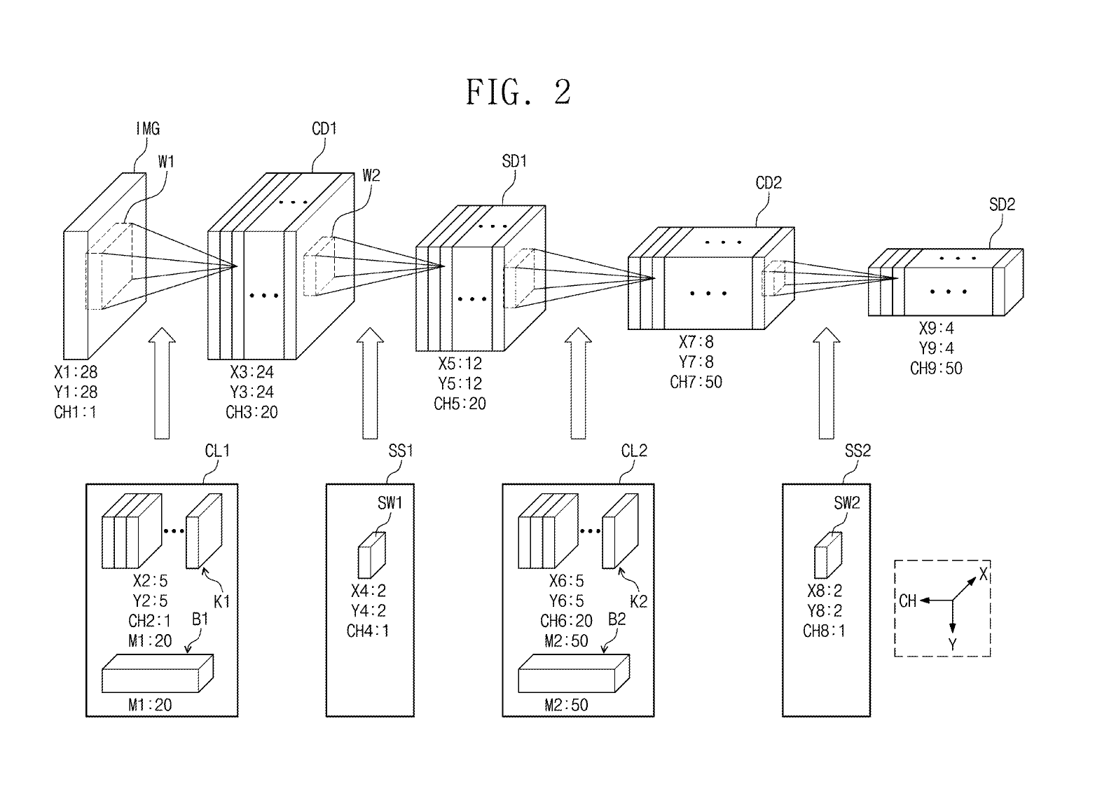

FIG. 2 shows an example in which image data IMG is processed by a plurality of layers of a CNN. In the following, each layer is specifically described using various numerical values, but the numerical values mentioned are exemplified to more easily explain the technical idea of the inventive concept. Numerical values mentioned below may be variously applied and changed, and do not limit the technical idea of the inventive concept.

Referring to FIG. 2, the image data IMG may have a size of 28 in the horizontal direction X1, 28 in the vertical direction Y1, and 1 in the channel CH1. For example, the size of the image data IMG may be measured by the number of pixel data.

A first convolution layer CL1 may be applied to the image data IMG. The first convolution layer CL1 may include first kernels K1 and a first bias B1. Each of the first kernels K1 may have a size of 5 in the horizontal direction X2, 5 in the vertical direction Y2, and 1 in the channel CH2. The size of the channel CH2 of each of the first kernels K1 may be the same as the size of input data, that is, the size of the channel CH1 of the image data IMG. The number M1 of the first kernels K1 may be 20. The number M1 of the first kernels K1 may be equal to the number of channels of data outputted through the first convolution layer CL1. For example, the size of the first kernels K1 may be measured by the number of synapses to be computed with the image data IMG.

The first bias B1 may include 20 synapses equal to the number M1 of the first kernels K1.

When the first convolution layer CL1 is applied, one of the first kernels K1 may be selected. The selected one kernel may be computed with the image data IMG as a first window W1. The first window W1 may move in a predetermined direction on the image data IMG. In the following, the movement of various windows is described using the term “position”. For example, the position of a window may indicate the position on the input data of a specific synapse (e.g., the uppermost and leftmost synapses in the window) belonging to the window. For example, the position of the window may indicate with which nth pixel data among pixel data a specific synapse is superimposed in the horizontal direction X and the vertical direction Y.

For example, the first window W1 may move from left to right at the selected first vertical position. When the first window W1 moves from the selected first vertical position to the rightmost position, the second vertical position below the selected first vertical position may be selected. The first window W1 can move from left to right at the selected second vertical position. The pixel data of the image data IMG corresponding to the first window W1 and the synapse data of the synapses of the first window W1 may be computed with each other at each position of the first window W1. Synapse data of the synapse corresponding to the position of the selected one of the synapses of the first bias B1 may be added to or subtracted from the calculation result. The data having the bias applied may form data (e.g., sample data) at the position of one of the output data (e.g., the first convolution data CD1).

For example, the position of the channel of the first convolution data CD1 where the sample data is disposed may correspond to the position of the selected one of the first kernels K1. The position of the horizontal direction X3 and the vertical direction Y3 of the first convolution data CD1 where the sample data is disposed may correspond to the position on the image data IMG of the first window W1.

When the synapses of one of the first kernels K1 and one synapse of the first bias B1 are applied to the image data IMG, the data of one channel of the first convolution data CD1 is generated. When 20 first kernels K1 are sequentially applied, 20 channels of the first convolution data CD1 may be sequentially generated. For example, the first kernels K1 may correspond to different image filters, respectively. The first convolution data CD1 may be a set of results with twenty different filters applied.

Since the size of the selected kernel is 5 in the horizontal direction X2 and 5 in the vertical direction Y2, the size of each channel of the first convolution data CD1 may be smaller than the size of the image data IMG. For example, when a space where the first window W1 is able to move on the image data IMG is calculated based on the uppermost leftmost point of the first window W1, the first window W1 may be disposed at twenty four different positions in the horizontal direction X1 and at twenty four different positions in the vertical direction Y1. Therefore, the first convolution data CD1 may have a size of 24 in the horizontal direction X3, 24 in the vertical direction Y3, and 20 in the channel CH3. For example, the size of the first convolution data CD1 may be measured by the number of sample data.

A first sub-sampling layer SS1 may be applied to the first convolution data CD1. The first sub-sampling layer SS1 may include a first sub-sampling kernel SW1. The first sub-sampling kernel SW1 may have a size of 2 in the horizontal direction X4, 2 in the vertical direction Y2, and 1 in the channel CH4.

The first sub-sampling kernel SW1 may be selected as the second window W2. The second window W2 may move on the first convolution data CD1. For example, twenty channels of the first convolution data CD1 may be sequentially selected, and the second window W2 may move in the selected channel. In the selected channel, the second window W2 may move in the same manner as the first window W1. At each position of the second window W2, sub-sampling may be performed. For example, sub-sampling may include selecting data having a maximum value among data belonging to each position of the second window W2. The result of the sub-sampling at the selected position of the selected channel may form one data (e.g., sample data) at the corresponding position of the corresponding channel of the output data (e.g., the first sub-sampling data SD1) of the first sub-sampling layer SS1.

For example, the stride of the second window W2 may be set to two. The stride may indicate a position difference as moving from the current position to the next position when the second window W2 moves. For example, the stride may indicate a position difference between a first position of the second window W2 and a second position immediately following the first position.

The first sub-sampling data SD1 may have a size of 12 in the horizontal direction X4, 12 in the vertical direction Y5, and 20 in the channel CH5. For example, the size of the first sub-sampling data SD1 may be measured by the number of sample data. A second convolution layer CL2 may be applied to the first sub-sampling data SD1. The second convolution layer CL2 may include second kernels K2 and a second bias B2. Each of the second kernels K2 may have a size of 5 in the horizontal direction X6, 5 in the vertical direction Y6, and 20 in the channel CH6. The number M2 of the second kernels K2 may be 50. The second bias B2 may include 50 synapses corresponding to the number M2 of the second kernels K2.

The number of channels CH2 of each of the second kernels K2 is equal to the number of channels CH5 of the first sub-sampling data SD1. Accordingly, the second convolution layer CL2 may be applied to the first sub-sampling data SD1 in the same manner as the first convolution layer CL1. For example, one selected kernel may calculate pixel data corresponding to twenty channels and synapses corresponding to twenty channels, at a specific position on the first sub-sampling data SD1. The second convolution layer CL2 may be applied in the same manner as the first convolution layer CL1 except that the number of channels of pixel data and synapses computed at one position is increased.

The result data having the second convolution layer CL2 applied may be the second convolution data CD2. Therefore, the second convolution data CD2 may have a size of 8 in the horizontal direction X7, 8 in the vertical direction Y7, and 50 in the channel CH7. The size of the second convolution data CD2 may indicate the number of sample data.

A second sub-sampling layer SS2 may be applied to the second convolution data CD2. The second sub-sampling layer SS2 may include a second sub-sampling kernel SW2. The second-sub sampling kernel SW2 may have a size of 2 in the horizontal direction X8, 2 in the vertical direction Y2, and 1 in the channel CH8. The second sub-sampling layer SS2 may be applied to the second convolution data CD2 in the same manner that the first sub-sampling layer SS1 is applied to the first convolution data CD1.

The result data having the second sub-sampling layer SS2 applied may be the second sub-sampling data SD2. The second sub-sampling data SD2 may have a size of 4 in the horizontal direction X9, 4 in the vertical direction Y9, and 50 in the channel CH9. The size of the second sub-sampling data SD2 may indicate the number of sample data.

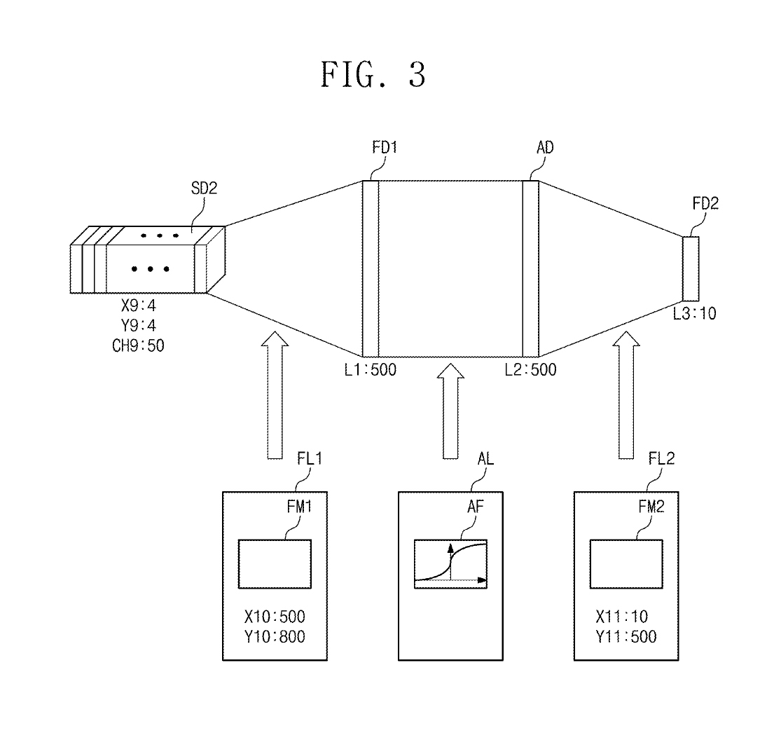

FIG. 3 further shows an example in which image data IMG is processed by a plurality of layers of the CNN. Referring to FIGS. 1 to 3, a first fully connected layer FL1 may be applied to the second sub-sampling data SD2. The first fully connected layer FL1 may include a first fully connected kernel FM1. The first fully connected kernel FM1 may have a size of 500 in the horizontal direction X10 and 800 in the vertical direction Y10.

For example, the size of the horizontal direction X10 of the first fully connected kernel FM1 corresponds to the number of sample data of the second sub-sampled data SD2, and the size of the vertical direction Y10 corresponds to the number of sample data of the first fully connected data FD1, which is the result having the first full fully connected layer FL1 applied. However, the size of the first fully connected kernel FM1 may vary depending on a fully connected structure and the number of hidden layers. For example, the first fully connected layer FL1 may further include a bias. For example, the bias may be a value added to or subtracted from the result having the first fully connected kernel FM1 applied. The bias may include values that vary depending on the same single value or position.

The length L1 of the first fully connected data FD1 may be 500. The length L1 of the first fully connected data FD1 may indicate the number of sample data. An active layer AL may be applied to the first fully connected data FD1. The active layer AL may include an active kernel AF. The active kernel AF may limit the values of sample data to values within a predetermined range, such as a sigmoid function.

The result having the active layer AL applied may be active data AD. The length L2 of the active data AD may be 500, which is equal to the length L1 of the first fully connected data FD1. A second fully connected layer FL2 may be applied to the active data AD. The second fully connected layer FL2 may include a second fully connected kernel FM2. The second fully connected kernel FM2 may have a size of 10 in the horizontal direction X11 and 500 in the vertical direction Y11.

For example, the size of the horizontal direction X11 of the second fully connected kernel FM2 corresponds to the number of sample data of the active data AD, and the size of the vertical direction Y11 corresponds to the number of sample data of the second fully connected data FD2, which is the result having the second fully connected layer FL2 applied. However, the size of the second fully connected kernel FM2 may vary depending on a fully connected structure and the number of hidden layers.

The second fully connected data FD2 may include identification information on objects included in the image IMG. The machine learning device 12 may apply the layers of the CNN shown in FIGS. 2 and 3 to the images stored in the image database 11, and compare information included in the second fully connected data FD2 with the image IMG. Depending on the comparison result, the machine learning device 12 may modify the synapse data of the synapses of a plurality of layers using back propagation. Modifications through computation, comparison, and back propagation using a plurality of layers may be repeated a plurality of times.

When the modification of synapse data by the machine learning device 12 is completed, that is, when the synapse data SD is determined, the machine learning device 12 may output the determined synapse data SD.

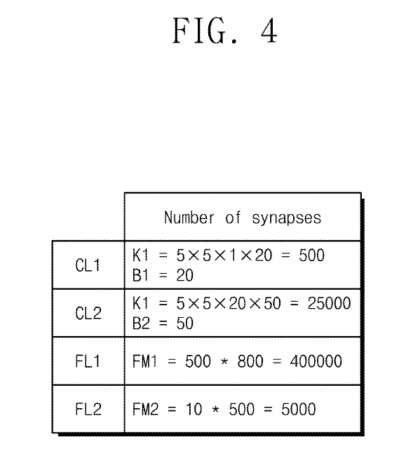

FIG. 4 is a table showing an example of the number of synapses of the layers of the CNN described with reference to FIGS. 2 and 3. Referring to FIGS. 1 to 4, the number of synapses of the first kernels K1 of the first convolution layer CL1 may be a multiplication of 5 which is the size of the horizontal direction X2 of each kernel, 5 which is the size of the vertical direction Y2 of each kernel, 1 which is the size of the channel CH2 of each kernel, and 20 which is the number of the first kernels K1. According to the calculation, the number of synapses of the first kernels K1 may be 500. The number of synapses of the first bias B1 of the first convolution layer CL1 is 20.

The number of synapses of the second kernels K2 of the second convolution layer CL2 may be a multiplication of 5 which is the size of the horizontal direction X6 of each kernel, 5 which is the size of the vertical direction Y6 of each kernel, 20 which is the size of the channel CH6 of each kernel, and 50 which is the number of the second kernels K2. According to the calculation, the number of synapses of the second kernels K2 may be 25000. The number of synapses of the second bias B2 of the second convolution layer CL2 is 50.

The number of synapses of the first fully connected kernel FM1 of the first fully connected layer FL1 is a multiplication of 500 which the size of the horizontal direction X10 of the first fully connected kernel FM1 and 800 which is the size of the vertical direction X10. According to the calculation, the number of synapses of the first fully connected kernel FM1 may be 400000.

The number of synapses of the second fully connected kernel FM2 of the second fully connected layer FL2 is a multiplication of 10 which the size of the horizontal direction X11 of the second fully connected kernel FM2 and 500 which is the size of the vertical direction X11. According to the calculation, the number of synapses of the second fully connected kernel FM2 may be 5000.

Each synapse has a value represented by a predetermined number of bits. Assuming that the value of each synapse is a float value without quantization, the synapse data of the synapses of the second kernels K2 corresponds to 100 KB, and the synapse data of the synapses of the second bias B2 corresponds to 100 KB. The size of the synapse data of all synapses is larger than this.

If the size of the synapse data is large, the resource required to identify an image using the CNN increases. Also, the speed of identifying an image using the CNN may be degraded. For example, when comparing three types of memory, the internal memory in a processor has a high speed low capacity feature. The random access memory outside the processor has a medium speed medium capacity feature. The storage circuit 110, such as a non-volatile memory, has a low speed and large capacity feature. If the capacity of synapse data is large enough to be driven in the storage circuit 110, the speed for identifying an image becomes low. If the capacity of synapse data is reduced enough to be stored in the external random access memory, the speed for identifying an image becomes medium. If the capacity of synapse data is further reduced enough to be driven in the internal memory of a processor, the speed for identifying an image becomes high. That is, as the capacity of synapse data decreases, the speed for identifying an image may be improved.

Embodiments of the inventive concept provide a convolution neural network device that uses a compression method used for identifying an image without decompression while compressing synapse data. In addition, embodiments of the inventive concept provide a convolution neural network device for identifying an image using compressed synapse data without decompression.

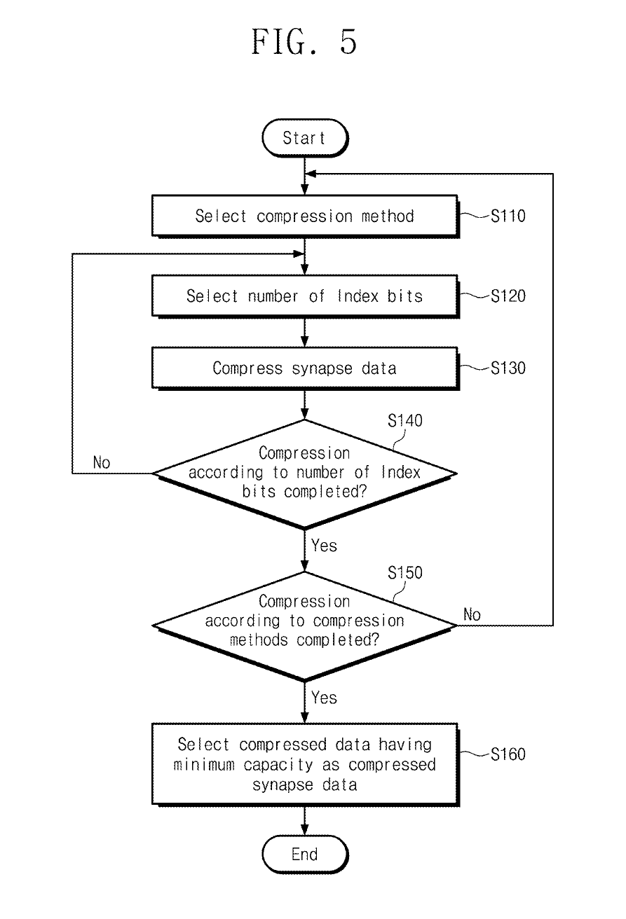

FIG. 5 shows an example of a method of compressing synapse data according to an embodiment of the inventive concept. Referring to FIGS. 1 and 5, in operation S110, the synapse data compressor 13 may select a compression method. For example, the synapse data compressor 13 may select one of a Compressed Sparse Row (CSR) and a run length.

In operation S120, the synapse data compressor 13 may select the number of index bits. The index bits may represent information (e.g., index or length) that is compressed during synapse data compression. Selecting the number of index bits may include selecting the number of bits to display compressed information. For example, the number of index bits may be selected from 4, 5, and 6, and is not limited.

In operation S130, the synapse data compressor 13 may compress synapse data. For example, the synapse data compressor 13 may compress synapse data based on its sparsity.

In operation S140, the synapse data compressor 13 determines whether compression based on the number of index bits is completed. If the compression according to the number of index bits is not completed, that is, if there is an index bit that is not compressed through a selected compression method, the synapse data compressor 13 may perform operation S120. In operation S120, the synapse data compressor 13 may select the next index bit (e.g., the index bit on which compression is not performed) and perform the synapse data compression of operation S130 again. If the compression according to the number of index bits is completed, operation S150 is performed.

In operation S150, the synapse data compressor 13 determines whether the compression according to compression methods is completed. If the compression according to compression methods is not completed, that is, if there is a compression method in which no compression is performed, the synapse data compressor 13 may select the next compression method (for example, a compression method in which no compression is performed) in operation S110. Thereafter, in operations S120 to S140, the synapse data compressor 13 may select the number of index bits to compress synapse data. If the compression according to compression methods is completed, operation S160 is performed.

In operation S160, the synapse data compressor 13 selects the compressed data having the minimum capacity as the final compressed synapse data. When operations S110 to S150 are performed, synapse data compressed for each compression method and for each number of index bits may be collected. The synapse data compressor 13 may select the data having the minimum capacity among the collected data as the final compressed synapse data.

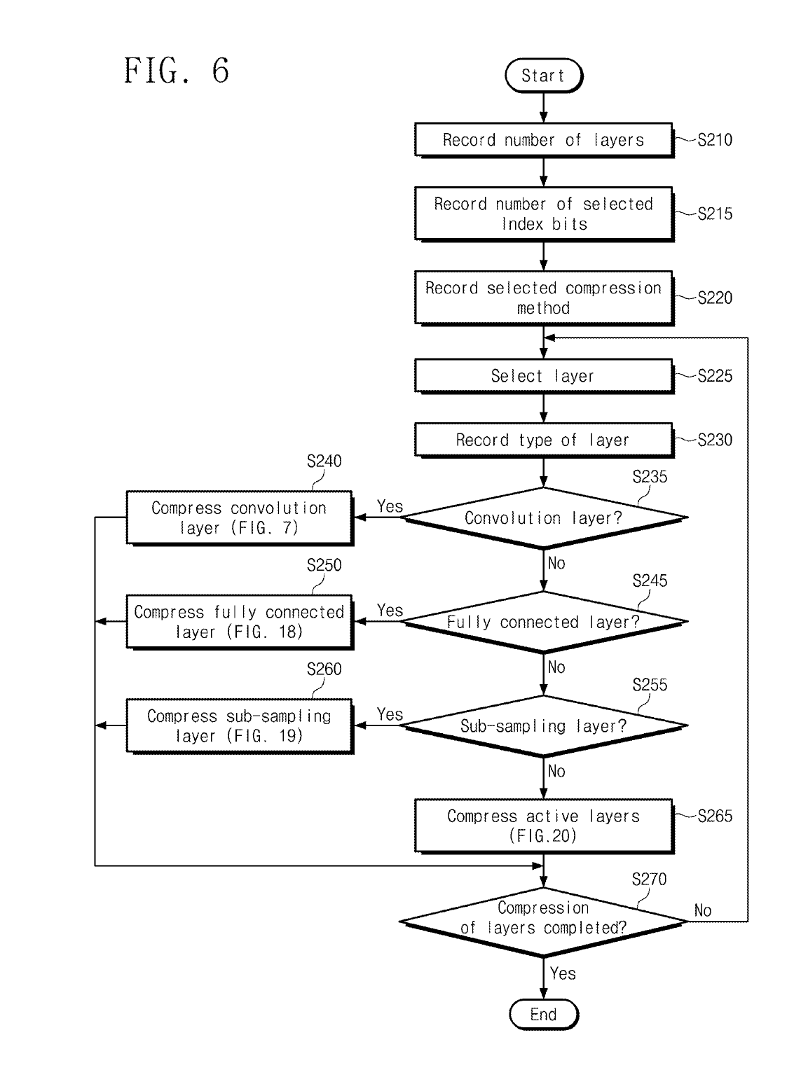

FIG. 6 is a flowchart showing an example of compressing synapse data (operation S130). Referring to FIGS. 1 to 3 and 6, in operation S210, the synapse data compressor 13 may record the number of layers of the CNN. For example, the number of layers may be recorded as part of the compressed synapse data SD_C.

In operation S215, the synapse data compressor 13 may record the number of selected index bits. The number of selected index bits may be recorded as part of the compressed synapse data SD_C.

In operation S220, the synapse data compressor 13 may record the selected compression method. The selected compression method may be recorded as part of the compressed synapse data SD_C.

In operation S225, the synapse data compressor 13 may select a layer. For example, the synapse data compressor 13 may select the first layer among the plurality of layers of the CNN.

In operation S230, the synapse data compressor 13 may record the type of the selected layer. The type of the selected layer may include a convolution layer, a sub-sampling layer, a fully connected layer, and an active layer. The type of the selected layer may be recorded as part of the compressed synapse data SD_C.

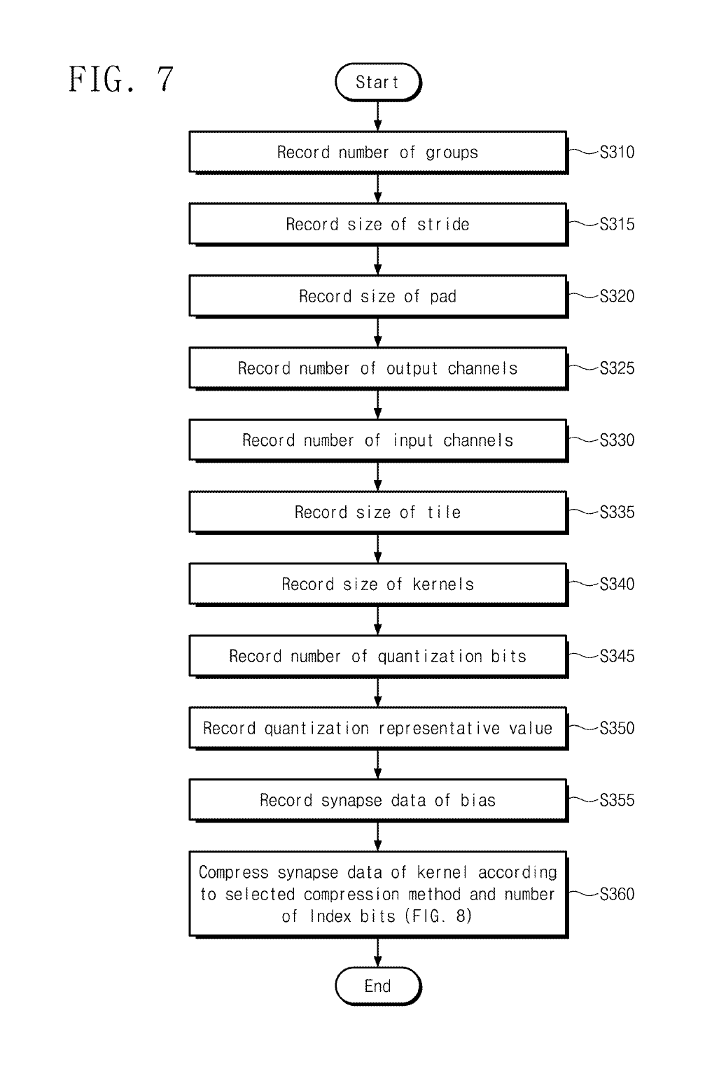

In operation S235, the synapse data compressor 13 determines whether the selected layer is a convolution layer. If the selected layer is a convolution layer, the synapse data compressor 13 may compress the selected convolution layer (see FIG. 7) in operation S240. Then, operation S270 may be performed. If the selected layer is not a convolution layer, operation S245 may be performed.

In operation S245, the synapse data compressor 13 determines whether the selected layer is a fully connected layer. If the selected layer is a fully connected layer, the synapse data compressor 13 may compress the selected fully connected layer (see FIG. 18) in operation S250. Then, operation S270 may be performed. If the selected layer is not a fully connected layer, operation S255 may be performed.

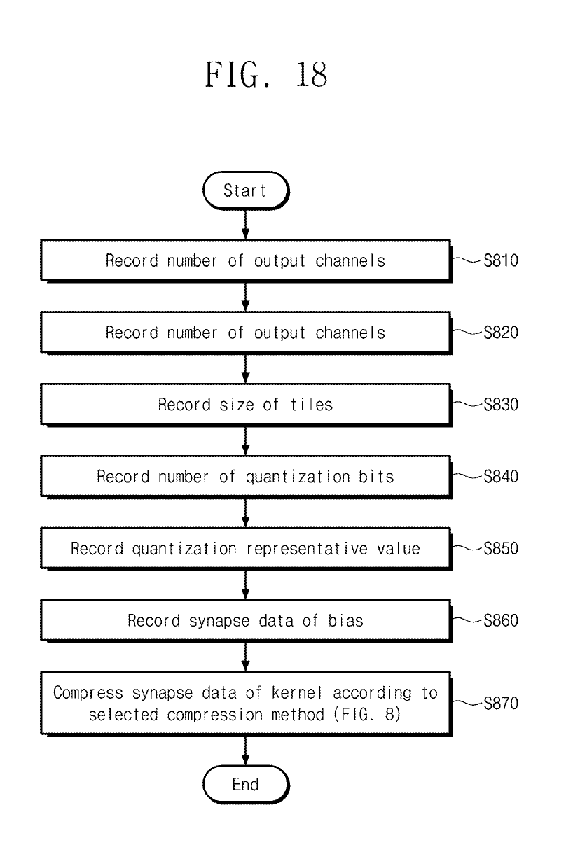

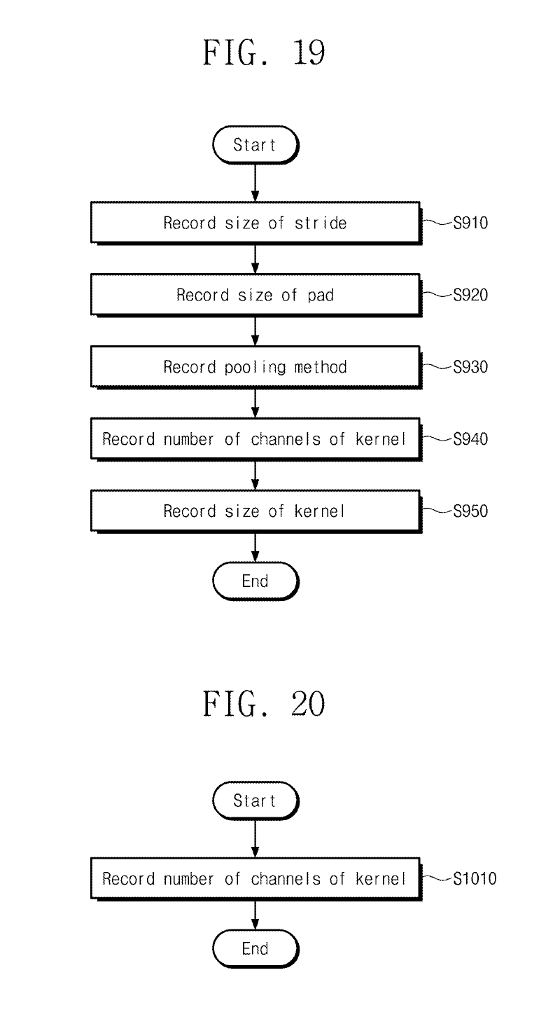

In operation S255, the synapse data compressor 13 determines whether the selected layer is a sub-sampling layer. If the selected layer is a sub-sampling layer, the synapse data compressor 13 may compress the selected sub-sampling layer (see FIG. 19) in operation S650. Then, operation S270 may be performed. If the selected layer is not a sub-sampling layer, operation S265 may be performed.

In operation S265, the selected layer may be an active layer. Thus, the synapse data compressor 13 may compress the selected active layer (see FIG. 20). Then, operation S270 is performed.

In operation S270, the synapse data compressor 13 determines whether the compression of layers is completed. If the compression of the layers is not completed, that is, if an uncompressed layer still exists, the synapse data compressor 13 may perform the next layer (e.g., an uncompressed layer) in operation S225. Thereafter, the synapse data compressor 13 may compress the synapse data through operations S230 to S265. If the compression of the layers is completed, the synapse data compressor 13 may terminate the compression related to the selected compression method and the selected index bits.

As described with reference to FIG. 6, the synapse data compressor 13 may vary the compression method according to the type of the selected layer. For example, if the selected layer is a convolution layer, the synapse data compressor 13 may compress the synapse data of the selected layer using the compression method of operation S240 (see FIG. 7). If the selected layer is a fully connected layer, the synapse data compressor 13 may compress the synapse data of the selected layer using the compression method of operation S250 (see FIG. 18). If the selected layer is a sub-sampling layer, the synapse data compressor 13 may compress the synapse data of the selected layer using the compression method of operation S260 (see FIG. 19). If the selected layer is an active layer, the synapse data compressor 13 may compress the synapse data of the selected layer using the compression method of operation S265 (see FIG. 20).

FIG. 7 is a flowchart showing an example of a method of compressing a convolution layer (operation S240). Referring to FIGS. 1 to 3 and 7, in operation S310, the synapse data compressor 13 may record the number of groups. For example, a plurality of convolution layers may be applied in parallel to input data. A plurality of convolution layers applied in parallel may be referred to as groups. The number of a plurality of convolution layers may be the number of groups. The number of groups may be recorded as part of the compressed synapse data SD_C.

In operation S315, the synapse data compressor 13 may record the size of a stride. As described with reference to the first sub-sampling layer SS1, the selected kernel of a convolution layer may move with a stride. The size of a stride may be recorded as part of the compressed synapse data SD_C.

In operation S320, the synapse data compressor 13 may record the size of a pad. For example, when the first convolution layer CL1 is applied, the size of the first convolution data CD1 becomes smaller than the size of the image data IMG. In order to prevent the size of data from decreasing, pads may be added to input data. The pads may include dummy sample data (or dummy pixel data) having a predetermined initial value (e.g., 0). The pads may be added along the horizontal direction X of input data, the reverse direction of the horizontal direction X, the vertical direction Y, the reverse direction of the vertical direction Y, or combined directions of at least two thereof. The size of a pad may be recorded as part of the compressed synapse data SD_C.

In operation S325, the synapse data compressor 13 may record the number of output channels. The number of output channels may be equal to the number of kernels. The number of output channels may be recorded as part of the compressed synapse data SD_C.

In operation S330, the synapse data compressor 13 may record the number of input channels. The number of input channels may be equal to the number of channels of each kernel. The number of input channels may be recorded as part of the compressed synapse data SD_C.

In operation S335, the synapse data compressor 13 may record the size of a tile. A tile may indicate the size of the synapse data inputted through a single transaction. The size of a tile may be recorded as part of the compressed synapse data SD_C.

In operation S340, the synapse data compressor 13 may record the size of kernels. The size of kernels may be recorded as part of the compressed synapse data SD_C.

In operation S345, the synapse data compressor 13 may record the number of quantization bits. The quantization bits may be bits representing the value of each sample data (or each pixel data or synapse data). The number of quantization bits may be the number of bits representing the value of each sample data (or each pixel data or synapse data). The number of quantization bits may be recorded as part of the compressed synapse data SD_C.

In operation S350, the synapse data compressor 13 may record a quantization representative value. The quantization representative value may be a maximum value that may be represented by quantization bits. The quantization representative value may be recorded as part of the compressed synapse data SD_C.

In operation S355, the synapse data compressor 13 may record the synapse data of a bias. For example, the synapse data compressor 13 may record the synapse data of the bias as part of the compressed synapse data SD_C without compressing the synapse data.

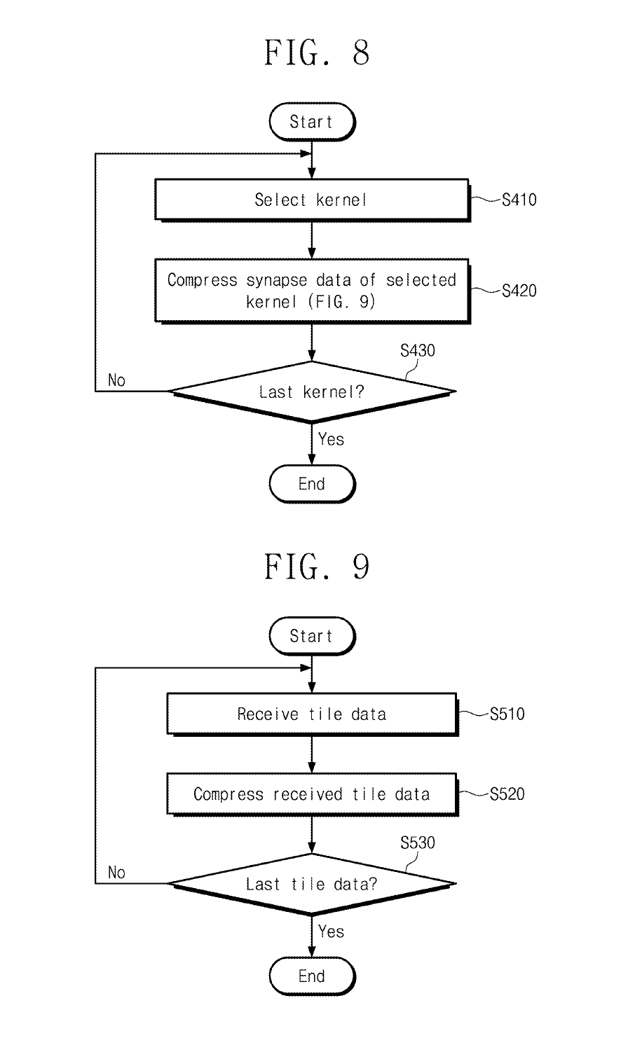

In operation S360, the synapse data compressor 13 compresses the synapse data of the kernel according to the selected compression method and the number of selected index bits (see FIG. 8).

FIG. 8 is a flowchart showing an example of a method of compressing the synapse data of a kernel (operation S360). Referring to FIGS. 1 to 3 and 8, in operation S410, the synapse data compressor 13 may select the first kernel.

In operation S420, the synapse data compressor 13 may compress the synapse data of the selected kernel (see FIG. 9).

In operation S430, the synapse data compressor 13 may determine whether compression of the last kernel is performed. For example, the synapse data compressor 13 may determine whether compression of all the kernels is performed. If compression of the last kernel is not performed, the synapse data compressor 13 may select the next kernel (e.g., a yet uncompressed kernel) in operation S410 and compress the selected next kernel in operation S420. If compression of the last kernel is performed, the synapse data compressor 13 may terminate the compression of the synapse data of the kernel in operation S430.

FIG. 9 is a flowchart showing an example of a method of compressing the synapse data of a selected kernel (operation S420). Referring to FIGS. 1 to 3 and 9, in operation S510, the synapse data compressor 13 may receive tile data. In operation S520, the synapse data compressor 520 may compress the received tile data.

In operation S530, the synapse data compressor 13 may determine whether compression of the last tile data of the selected kernel is completed. For example, the synapse data compressor 13 may determine whether compression of all tile data of the selected kernel is completed. If the compression of the last tile data is not completed, the synapse data compressor 13 receives the next tile data (e.g., yet uncompressed tile data) in operation S510 and compresses the received next tile data in operation S520. When the compression of the last tile data is completed, the synapse data compressor 13 may terminate the compression of the synapse data of the selected kernel.

For example, FIGS. 8 and 9 are described on the assumption that the capacity of synapse data of one kernel is larger than the capacity of one tile data. However, if the capacity of synapse data of one kernel is equal to the capacity of one tile data, the compression of synapse data of the selected kernel may be completed by performing only one of FIGS. 8 and 9. If the capacity of synapse data of one kernel is less than the capacity of one tile data, FIG. 9 may be performed first and FIG. 8 may be performed later. For example, the synapse data compressor 13 may receive tile data and compress synapse data included in the received tile data. The synapse data compressor 13 may receive the tile data and compress the synapse data until the compression of the last tile data related to the synapse data of the kernels of the selected convolution layer is completed. The synapse data compressor 13 sequentially selects the kernels from the received tile data and compresses the synapse data of the selected kernel.

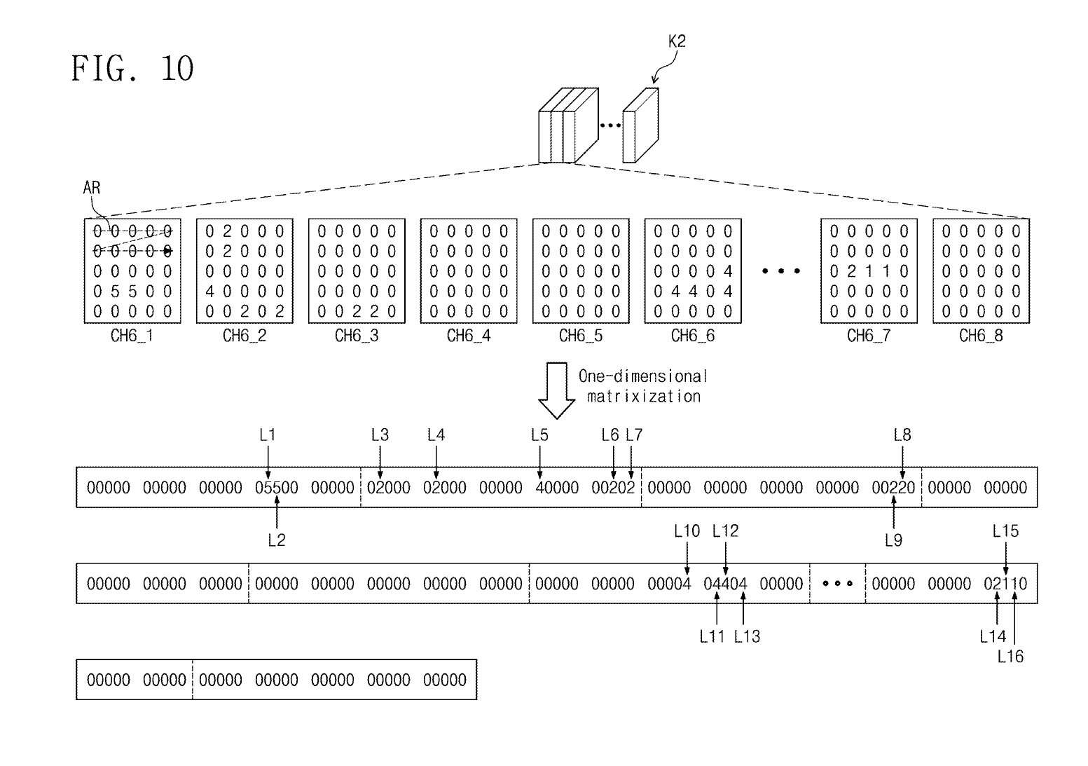

FIG. 10 shows an example in which synapse data of synapses of second kernels K2 is rearranged in order to explain the compression of the second kernels K2. Referring to FIGS. 2 and 10, each kernel includes synapses corresponding to 20 channels CH6_1 to CH6_20. Each channel has synapses of 5 in the horizontal direction X6 and 5 in the vertical direction Y6. Each synapse may have a value (e.g., synapse data) within a range determined by the number of quantization bits. For example, an example of synapse data of synapses of one kernel is shown in FIG. 10.

The synapse data may be a one-dimensional matrix along the direction indicated by the arrow AR. In the one-dimensional matrix, the number of non-zero values is sparse. The positions of the non-zero values are represented by the first to fifteenth positions L1 to L15. The synapse data compressor 13 according to an embodiment of the inventive concept may compress synapse data using its sparsity.

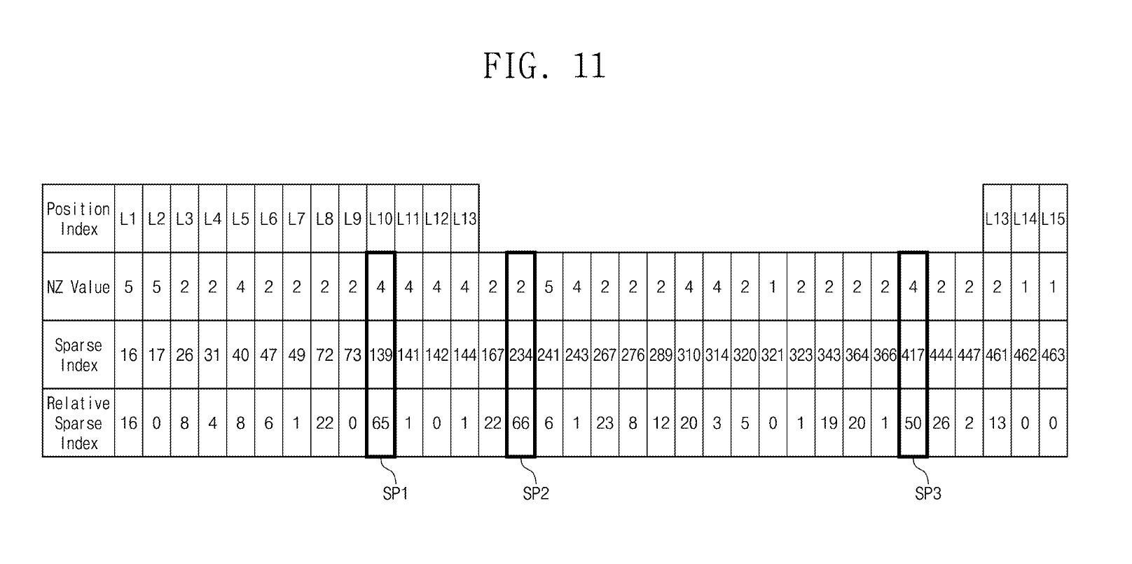

FIG. 11 shows an example of recording a one-dimensional matrix of FIG. 10 depending on a Compressed Sparse Row (CSR) method according to an embodiment of the inventive concept. Referring to FIGS. 10 and 11, synapse data may be represented by a Non-Zero (NZ) value and a sparse index according to the CSR method. To further easily illustrate the CSR method according to an embodiment of the inventive concept, positions L1 to L15 assigned to the NZ values in FIG. 10 are indicated by position indexes. In order to more easily explain the CSR method according to the embodiment of the inventive concept, the position values of the NZ values of FIG. 10, that is, values indicating at which nth position NZ values are disposed in one-dimensional matrix, are displayed by sparse indexes.

In the one-dimensional matrix, the first NZ value is placed in the first position L1 and its value is 5. Therefore, 5 may be recorded as the NZ value. In a one-dimensional matrix, the position value of the first position L1 corresponds to 17. Therefore, 16 obtained by subtracting 1 from the position value of the first position L1 may be recorded as a sparse index. For example, a value represented by bits starts from 0, so that a sparse index corresponding to the position value of 1 may be 0. Therefore, the position value corresponding to the position value of 17 may be 16 obtained by subtracting 1 from 17.

As described above, there is a difference between a value represented by bits and a value represented by the number of values (or an ordinal number). Therefore, when a value represented by a number (or an ordinal number) is represented by bits, the value of 1 should be subtracted. Conversely, when a value represented by bits is represented by a number (or an ordinal number), the value of 1 should be added. 1 may be an adjustment constant.

A relative sparse index may be a value obtained by subtracting 1 from a difference of a sparse index between the current NZ value and the previous NZ value. For example, since a value represented by bits starts from 0, a value obtained by subtracting 1 from the difference of a sparse index may be recorded as a relative sparse index. Since the NZ value does not exist before the first position L1, the relative sparse index of the first position L1 is a value (i.e., 16) obtained by subtracting 1 from the difference (i.e., 17) between the first value (i.e., 0) of the sparse index and 16 which is the sparse index of the first position L1. Therefore, 16 may be recorded as a relative sparse index of the first position L1.

The NZ value subsequent to the first position L1 is disposed at the second position L2. The NZ value of the second position L2 is 5. Therefore, 5 may be recorded as the second NZ value. The position value of the second position L2 is 18. Therefore, 17 may be recorded as a sparse index. The relative sparse index corresponding to the second position L2 is a value (i.e., 0) obtained by subtracting 1 from the difference (i.e., 1) between the sparse index (i.e., 17) of the current NZ value and the sparse index (i.e., 16) of the previous NZ value. Therefore, 0 may be recorded as a relative sparse index of the second position L2.

The NZ value subsequent to the second position L2 is disposed at the third position L3. The NZ value of the third position L3 is 2. Therefore, 2 may be recorded as the third NZ value. The position value of the third position L3 is 27. Therefore, 26 may be recorded as a sparse index. The relative sparse index corresponding to the third position L3 is a value (i.e., 8) obtained by subtracting 1 from the difference (i.e., 9) between the sparse index (i.e., 26) of the current NZ value and the sparse index (i.e., 17) of the previous NZ value. Therefore, 8 may be recorded as a relative sparse index of the third position L3.

As described with reference to the NZ values of the first to third positions L1 to L3, ‘2, 4, 2, 2, 2, 4, 4, 4, 4’ may be recorded as the NZ values corresponding to the fourth to the thirteenth positions L4 to L13, respectively. Sparse indexes corresponding to the fourth to thirteenth positions L4 to L13 may be ‘1, 40, 47, 49, 72, 73, 139, 141, 142, 144’, respectively. ‘4, 8, 6, 1, 22, 0, 65, 1, 0, 1’ may be recorded as the relative sparse indexes corresponding to the fourth to thirteenth positions L4 to L13, respectively. The NZ value, the sparse index, and the relative sparse index of the tenth position L10 are denoted by the first specific point SP1 to provide a description associated with the index bits, and a detailed description will be given later.

Although not shown in FIG. 10 to prevent the drawing from becoming too complicated, the synapse data or the values of the one-dimensional matrix, omitted in FIG. 10, are further shown in FIG. 11. The NZ values of ‘2, 2, 5, 4, 2, 2, 2, 4, 4, 2, 1, 2, 2, 2, 2, 4, 2 and 2’ may be additionally recorded next to the thirteenth position L13. The sparse indexes corresponding to the additionally-added NZ values may be ‘167, 234, 241, 243, 267, 276, 289, 310, 314, 320, 321, 323, 343, 364, 366, 417, 444, 447’, respectively. In correspondence to the additionally-recorded NZ values, ‘22, 66, 6, 1, 23, 8, 12, 20, 3, 5, 0, 1, 19, 20, 1, 50, 26, 2’ may be recorded as relative sparse indexes, respectively. Like the first specific point SP1, the second and third specific points SP2 and SP3 are shown to provide a description of the index bits, and a detailed description will be given later.

‘2, 1, 1’ may be recorded as NZ values corresponding to the thirteenth to fifteenth positions L13 to L15, respectively, following the additionally-recorded NZ values. Sparse indexes corresponding to the thirteenth to fifteenth positions L13 to L15, respectively, may be ‘2, 1, 1’. For the thirteenth to fifteenth positions L13 to L15, ‘13, 0, 0’ may be recorded as relative sparse indexes, respectively.

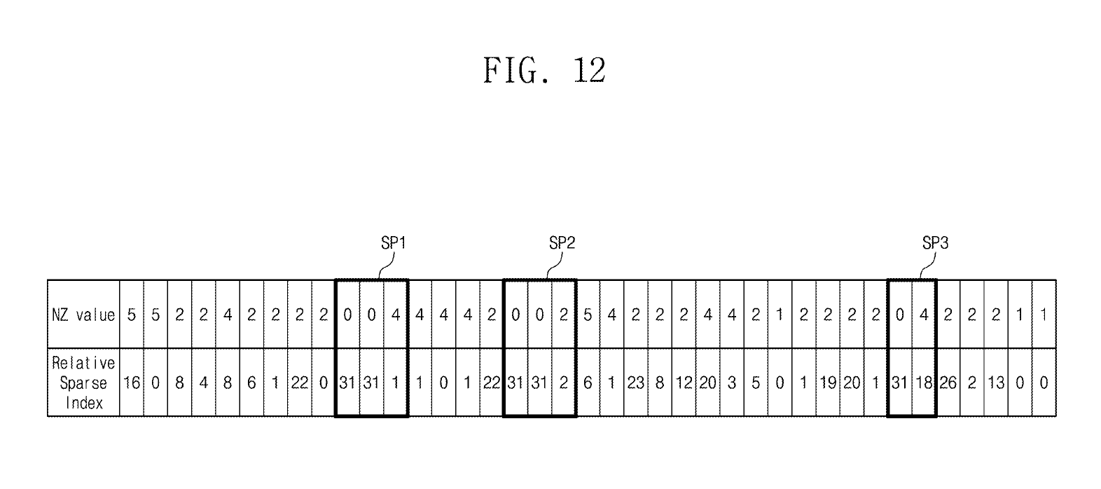

FIG. 12 shows an example of actually recording NZ values and relative sparse indexes of FIG. 11 with reference to index bits. For example, it is assumed that the number of index bits is 4. That is, a relative sparse index may be represented (e.g., to be quantized) by values within the range of 0 to 31.

Referring to FIGS. 11 and 12, relative sparse indexes in the range of 0 to 31 may be normally recorded. However, the relative sparse indexes of the first to third specific points SP1 to SP3 exceed the range of 0 to 31. When a specific point occurs, it may be recorded as two or more sparse indexes (i.e., two or more sets of index bits).

The number of sparse indexes (i.e., two or more sets of index bits) may be a value obtained by adding 1 to the quotient of dividing a sparse index by a value (i.e., 32) obtained by adding (e.g., reflecting an adjustment constant) 1 to the maximum value (i.e., 31) of one set of index bits. The last sparse index (i.e., a set of the last index bits) may be the remainder of dividing the sparse index by a value (i.e., 32) obtained by adding (e.g., reflecting an adjustment constant) 1 to the maximum value (i.e., 31) of the sparse index. The maximum value of index bits of another sparse index (i.e., a set of other index bits) other than the last sparse index (i.e., a set of last index bits) may be 31. For example, at the first specific point SP1, ‘0, 0, 4’ are recorded as the NZ value, and ‘31, 31, 1’ are recorded as the relative sparse index.

In the example described above, recording 0 as the NZ value should be interpreted as an indication (or a flag) indicating that the relative sparse index should be added to the relative sparse index of the following NZ value, rather than being interpreted as indicating that the NZ value is 0. At the first specific point SP1, since the first NZ value is 0, the relative sparse index (i.e., 31) is added to the relative sparse index (i.e., 1) of the following NZ value (i.e., 4). Each time a relative sparse index is calculated, since it is reduced by 1 by reflecting an adjustment constant, 1 may be added when the relative sparse index (i.e., 31) is added to the relative sparse index (i.e., 1) of the following NZ value (i.e., 4). Since the second NZ value is 0, the relative sparse index (i.e., 31) is added to the relative sparse index (i.e., 1) of the following NZ value (i.e., 4). Each time a relative sparse index is calculated, since it is reduced by 1 by reflecting an adjustment constant, 1 may be added when the relative sparse index (i.e., 31) is added to the relative sparse index (i.e., 1) of the following NZ value (i.e., 4). Thus, the relative sparse index of the NZ value of 4 may be identified as 65.

As described with reference to the first specific point SP1, the NZ values of the second specific point SP2 may be recorded as ‘0, 0, 2’ and the relative sparse indexes may be recorded as ‘31, 31, 2’, respectively. The NZ values of the third specific point SP3 may be recorded as ‘0, 4’ and the relative sparse indexes may be recorded as ‘31, 18’, respectively.

As described above, according to the CSR method based on the technical idea of the inventive concept, the synapse data in FIG. 10 may be compressed as shown in FIG. 12. Referring to the compressed synapse data of FIG. 12, without an additional calculation process (e.g., decompression), at which position of synapse data 0 is disposed, at which position an NZ value is disposed, and what an NZ value is may be identified. Thus, the compressed synapse data of FIG. 12 may be used to use the CNN (e.g., to identify an image) without decompression.

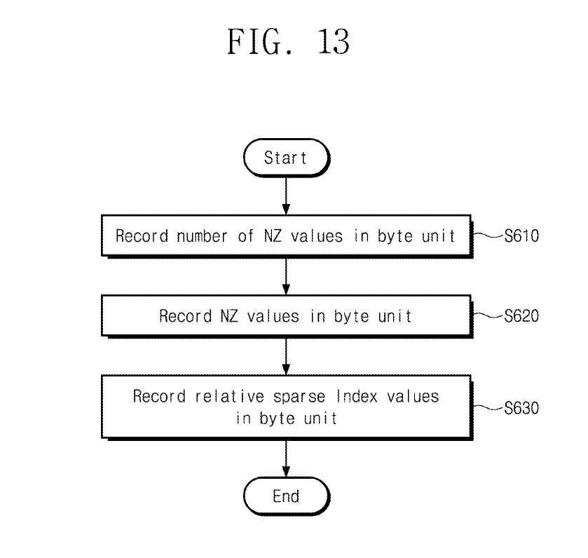

FIG. 13 is a flowchart showing an example of compressing synapse data according to a CSR method. Referring to FIGS. 1 and 13, in operation S610, the synapse data compressor 13 may record the number of NZ values in byte unit. In operation S620, the synapse data compressor 13 may record NZ values in byte unit. The NZ values may be extracted and recorded as shown in FIG. 12. In operation S630, the synapse data compressor 13 may record relative sparse index values in byte unit. The relative sparse index values may be extracted and recorded as shown in FIG. 12.

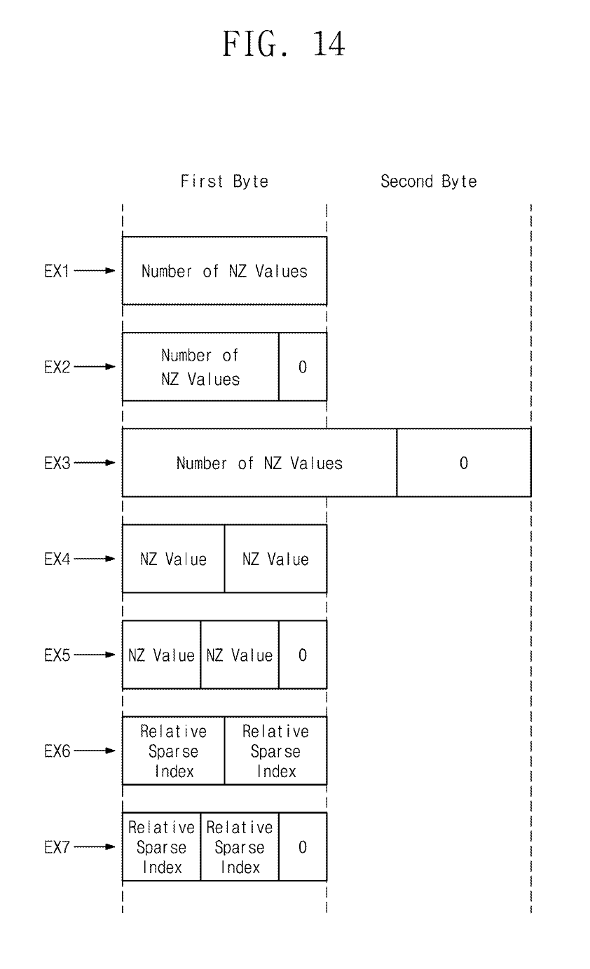

FIG. 14 shows examples in which the number of NZ values, the NZ values, and the relative sparse index are recorded in byte unit. In order to describe the recording in byte unit, the first byte and the second byte are shown in FIG. 14.

Referring to the first example EX1, the number of NZ values may be represented by eight bits (i.e., 1 byte). In this case, no additional processing is performed on the number of NZ values. The synapse data compressor 13 (see FIG. 1) may record the number of NZ values corresponding to 1 byte.

Referring to the second example EX2, the number of NZ values may be represented by the number of bits less than 8 (e.g., 6 bits). The synapse data compressor 13 may extend the number of NZ values into 1 byte by adding dummy bits to the number of NZ values. The synapse data compressor 13 may record the number of NZ values extending into 1 byte. For example, the dummy bit may have a value of 0.

Referring to the third example EX3, the number of NZ values may be represented by the number of bits greater than 8 and less than 16 (e.g., 10 bits). That is, the number of NZ values may be represented by bits greater than 1 byte and less than 2 bytes. The synapse data compressor 13 may extend the number of NZ values into 2 bytes by adding dummy bits to the number of NZ values. The synapse data compressor 13 may record the number of NZ values extending into 2 bytes.

Referring to the fourth example EX4, the size of 1 byte may be an integer multiple of the number of index bits. For example, index bits are 4, and two NZ values may form 1 byte. The synapse data compressor 13 may combine two NZ values to form 1 byte, and record two NZ values bounded as 1 byte.

Referring to the fifth example EX5, the size of 1 byte may not be an integer multiple of the number of index bits. For example, the index bits may be 3. The size of the two NZ values may be smaller than the size of 1 byte, and the size of the three NZ values may be greater than the size of 1 byte. The synapse data compressor 13 may expand the size of two NZ values into 1 byte by grouping two NZ values and adding dummy bits. The synapse data compressor 13 may record two NZ values extending into 1 byte.

Referring to the sixth example EX6, the size of 1 byte may be an integer multiple of the number of index bits. For example, index bits are 4, and two relative sparse indexes may form 1 byte. The synapse data compressor 13 may group two relative sparse indexes to form 1 byte and record two relative sparse indexes bounded as 1 byte.

Referring to the fifth example EX5, the size of 1 byte may not be an integer multiple of the number of index bits. For example, the index bits may be 3. The size of the two relative sparse indexes may be smaller than the size of 1 byte, and the size of the three relative sparse indexes may be greater than the size of 1 byte. The synapse data compressor 13 may expand the size of two relative sparse indexes into 1 byte by grouping two relative sparse indexes and adding dummy bits. The synapse data compressor 13 may record two relative sparse indexes extending into 1 byte.

For example, if the number of index bits is greater than the size of 1 byte and less than the size of 2 bytes, the NZ value and the relative sparse index may be recorded as in the third example EX3.

For example, the technical idea of the inventive concept is not limited to the recording in byte unit. For example, the number of NZ values, NZ values, and relative sparse indices may be recorded as 2 bytes, k bytes (k is a positive integer), i kilobytes (i is a positive integer), and so on. For example, the number of NZ values, the NZ values, and the relative sparse indexes may be defined corresponding to the input/output unit or input/output bandwidth of the synapse data compressor 13, or the input/output unit or input/output bandwidth that the image identification device 100 uses to identify an image. If the number of NZ values, the NZ values, and the relative sparse indexes are defined to correspond to an input/output unit or an input/output bandwidth, compression of synapse data and identification of an image using compressed synapse data may be simplified and have an improved speed.

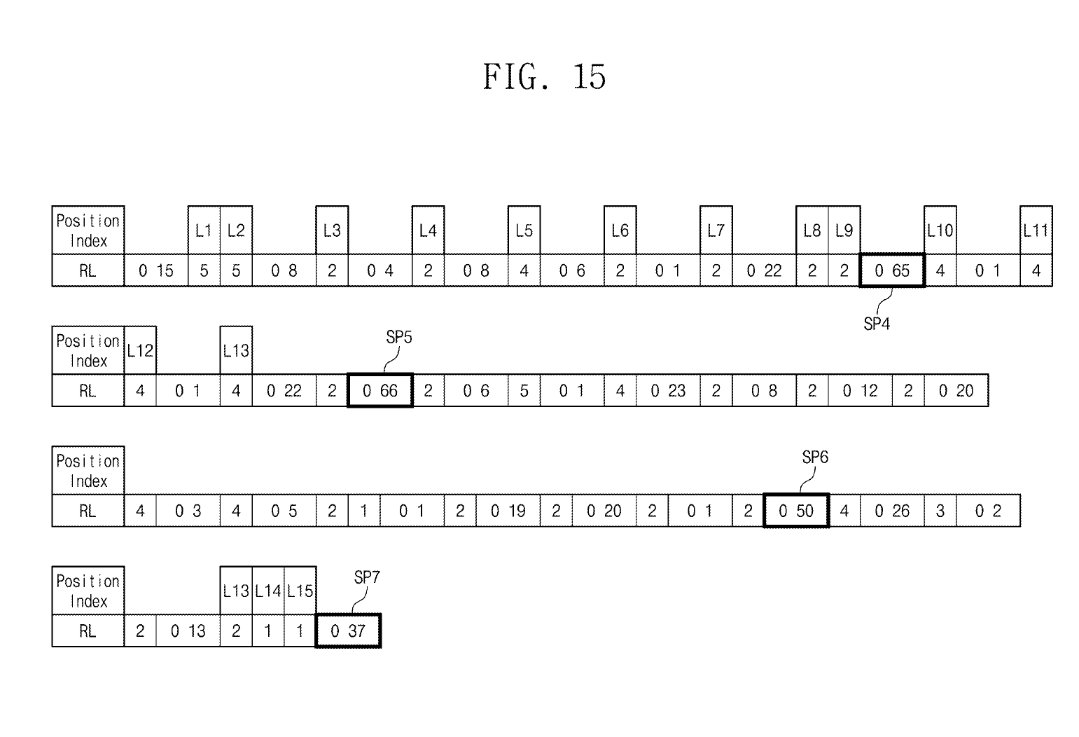

FIG. 15 shows an example of recording a one-dimensional matrix of FIG. 10 depending on a Run Length (RL) method according to an embodiment of the inventive concept. Referring to FIGS. 10 and 15, the synapse data may be represented by the number of consecutive zero values and an NZ value according to the RL method. To further easily illustrate the RL method according to an embodiment of the inventive concept, positions L1 to L15 assigned to the NZ values in FIG. 10 are indicated by position indexes. In order to more easily explain the CSR method according to the embodiment of the inventive concept, the position values of the NZ values of FIG. 10, that is, values indicating at which nth position NZ values are disposed in one-dimensional matrix, are displayed by sparse indexes.

In a one-dimensional matrix, there are 16 zero values until the first position L1. As the run length RL, a zero value and the number of zero values may be recorded. The number of zero values may be recorded as 15, which is reduced by 1, by reflecting an adjustment constant.

Thereafter, an NZ value (i.e., 5) corresponding to the first position L1 is recorded as the run length RL. Thereafter, an NZ value (i.e., 5) corresponding to the second position L2 is recorded as the run length RL. Between the second position L2 and the third position L3, there are nine zero values. The number (i.e., 8) of zero values reflecting a zero value and an adjustment constant may be recorded as the run length RL.

Thereafter, an NZ value (i.e., 2) corresponding to the third position L3 is recorded. Thereafter, five zero values are recorded as 0 and 4, respectively. An NZ value (i.e., 2) of the fourth position L4 is recorded, and 0 and 8 are recorded. An NZ value (i.e., 4) of the fifth position L5 is recorded, and 0 and 1 are recorded. An NZ value (i.e., 2) of the sixth position L6 is recorded, and 0 and 6 are recorded. An NZ value (i.e., 2) of the seventh position L7 is recorded, and 0 and 22 are recorded. An NZ value (i.e., 2) of the eighth position L8 is recorded, and an NZ value (i.e., 2) of the ninth position L9 is recorded, and 0 and 65 are recorded.

Then, an NZ value (i.e., 4) of the tenth position L10 is recorded, and 0 and 1 are recorded. NZ values (i.e., 4 and 4) of the eleventh and twelfth positions L11 and L12 are recorded, and 0 and 1 are recorded. An NZ value (i.e., 4) of the thirteenth position L13 is recorded, and 0 and 22 are recorded.

Then, an NZ value (i.e., 2) is recorded, and 0 and 66 are recorded. An NZ value (i.e., 2) is recorded, and 0 and 6 are recorded. An NZ value (i.e., 5) is recorded, and 0 and 1 are recorded. An NZ value (i.e., 4) is recorded, and 0 and 23 are recorded. An NZ value (i.e., 2) is recorded, and 0 and 8 are recorded. An NZ value (i.e., 2) is recorded, and 0 and 12 are recorded. An NZ value (i.e., 2) is recorded, and 0 and 20 are recorded. An NZ value (i.e., 4) is recorded, and 0 and 3 are recorded. An NZ value (i.e., 4) is recorded, and 0 and 5 are recorded. NZ values (i.e., 2 and 1) are recorded, and 0 and 1 are recorded. An NZ value (i.e., 2) is recorded, and 0 and 19 are recorded. An NZ value (i.e., 2) is recorded, and 0 and 20 are recorded. An NZ value (i.e., 2) is recorded, and 0 and 1 are recorded. An NZ value (i.e., 2) is recorded, and 0 and 50 are recorded. An NZ value (i.e., 4) is recorded, and 0 and 26 are recorded. An NZ value (i.e., 3) is recorded, and 0 and 2 are recorded. An NZ value (i.e., 2) is recorded, and 0 and 13 are recorded.

Then, NZ values (i.e., 2, 1, and 1) are recorded at the thirteenth to fifteenth positions L13 to L15, and 37 is recorded.

In the run length RL, a dividing line is shown between values in order to more easily explain the technical idea of the inventive concept. However, the data of the actual run length RL may be consecutive values without dividing lines.

In the run length RL, a value following the zero value represents a value, which is reduced by 1, by reflecting an adjustment constant to the number of zeros. An NZ value not following a zero value represents an actual synapse data value at the actual corresponding location.

In order to provide a description related to the number of index bits, the fourth to seventh specific points SP4 to SP7 are shown in FIG. 15. Details will be described later.

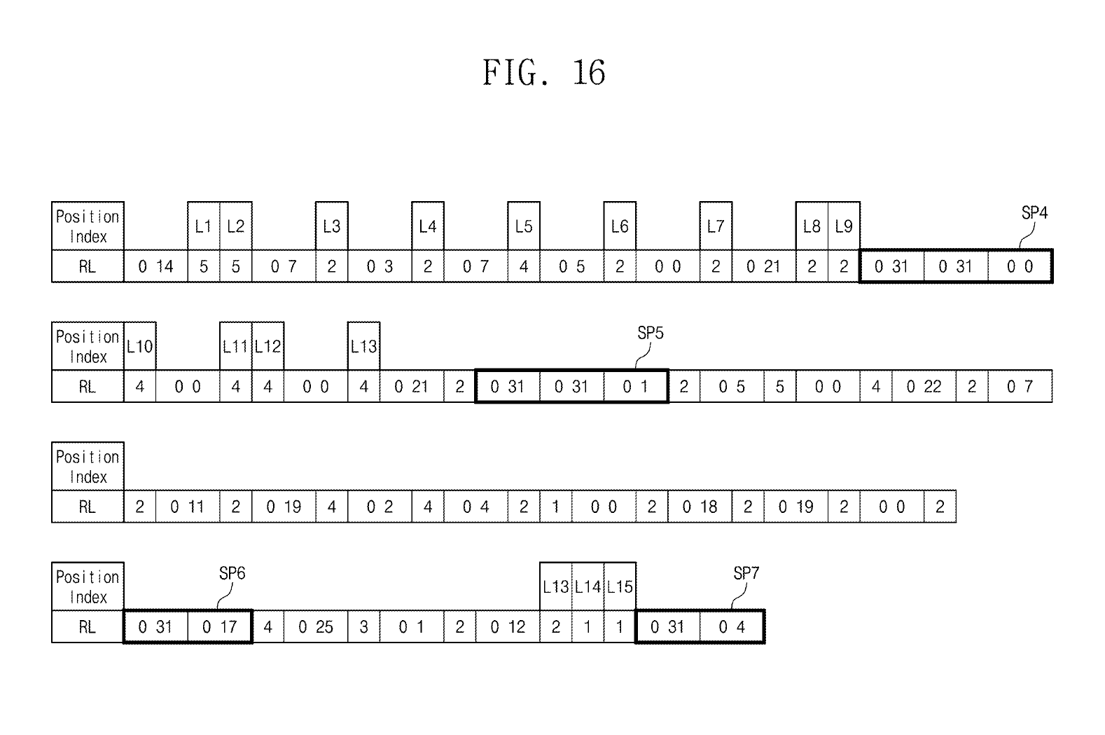

FIG. 16 shows an example of actually recording the values of the run length RL of FIG. 15 with reference to index bits. For example, it is assumed that the number of index bits is 4. That is, each value of the run length RL may be represented (e.g., to be quantized) by values within the range of 0 to 31.

Referring to FIGS. 15 and 16, values in the range of 0 to 31 may be normally recorded. However, each of the numbers of zero values of the fourth to seventh specific points SP4 to SP7 exceeds the range of 0 to 31. When a specific point occurs, it may be recorded as two or more sets of index bits.

The number of sets of index bits may be a value obtained by adding 1 to the quotient of dividing a value of the run length RL by a value (i.e., 32) obtained by adding 1 by reflecting an adjustment constant to the maximum value (i.e., 31) of index bits. The last set of index bits may indicate a value obtained by subtracting 1 by reflecting an adjustment constant from the remainder of dividing a value of the run length RL by a value (i.e., 32) obtained by adding 1 by reflecting the adjustment constant to the maximum value (i.e., 31) of the index bits. Each of the non-last sets of index bits may indicate the maximum value (i.e., 31) of index bits.

For example, a value ‘0, 65’ of the run length RL of the fourth specific point SP4 may be recorded as values of the run length RL of ‘0, 31, 0, 31, 0, 0’ by reflecting the number of index bits. For example, a value ‘0, 66’ of the run length RL of the fifth specific point SP5 may be recorded as values of the run length RL of ‘0, 31, 0, 31, 0, 1’ by reflecting the number of index bits. For example, a value ‘0, 50’ of the run length RL of the sixth specific point SP6 may be recorded as values of the run length RL of ‘0, 31, 0, 17’ by reflecting the number of index bits. For example, a value ‘0, 37’ of the run length RL of the seventh specific point SP7 may be recorded as values of the run length RL of ‘0, 31, 0, 4’ by reflecting the number of index bits.

As described above, according to the RL method based on the technical idea of the inventive concept, the synapse data in FIG. 10 may be compressed as shown in FIG. 16. Referring to the compressed synapse data of FIG. 16, without an additional calculation process (e.g., decompression), at which position of synapse data a zero value is disposed, at which position an NZ value is disposed, and what an NZ value is may be identified. Thus, the compressed synapse data of FIG. 16 may be used to use the CNN (e.g., to identify an image) without decompression.

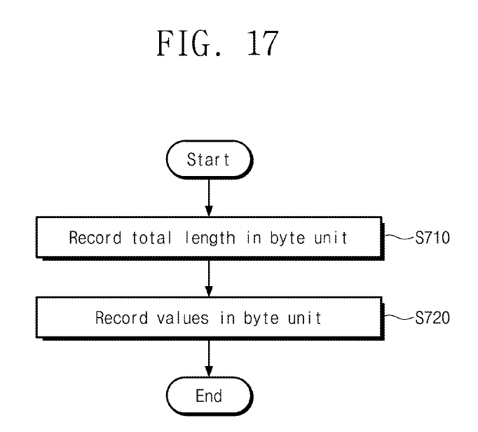

FIG. 17 is a flowchart showing an example of compressing synapse data according to an RL method. Referring to FIGS. 1 and 17, in operation S710, the synapse data compressor 13 may record the total length of values of the run length (RL) in byte unit. In operation S720, the synapse data compressor 13 may record the values of the run length RL in byte unit. For example, the recording in byte unit is performed in the same manner as described with reference to FIG. 14, and therefore, redundant explanations are omitted.

FIG. 18 is a flowchart showing an example of a method of compressing a fully connected layer (operation S250). Referring to FIGS. 1 to 3 and 18, in operation S810, the synapse data compressor 13 may record the number of output channels. The number of output channels may be recorded as part of the compressed synapse data SD_C.

In operation S820, the synapse data compressor 13 may record the number of input channels. The number of input channels may be recorded as part of the compressed synapse data SD_C.

In operation S830, the synapse data compressor 13 may record the size of a tile. The size of a tile may be recorded as part of the compressed synapse data SD_C.

In operation S840, the synapse data compressor 13 may record the number of quantization bits. The number of quantization bits may be recorded as part of the compressed synapse data SD_C.

In operation S850, the synapse data compressor 13 may record a quantization representative value. The quantization representative value may be recorded as part of the compressed synapse data SD_C.

In operation S860, the synapse data compressor 13 may record the synapse data of a bias. For example, the synapse data compressor 13 may record the synapse data of the bias as part of the compressed synapse data SD_C without compressing the synapse data.

In operation S870, the synapse data compressor 13 compresses the synapse data of the kernel according to the selected compression method and the number of selected index bits (see FIG. 8).

FIG. 19 is a flowchart showing an example of a method of compressing a sub-sampling layer (operation S260). Referring to FIGS. 1 to 3 and 19, in operation S910, the synapse data compressor 13 may record the size of a stride. The size of a stride may be recorded as part of the compressed synapse data SD_C.

In operation S920, the synapse data compressor 13 may record the size of a pad. The size of a pad may be recorded as part of the compressed synapse data SD_C.

In operation S930, the synapse data compressor 13 may record a pooling method. The pooling method may include selecting a maximum value, selecting a minimum value, selecting an intermediate value, selecting an average value, and the like. The pooling method may be recorded as part of the compressed synapse data SD_C.

In operation S940, the synapse data compressor 13 may record the number of kernel channels. The number of kernel channels may be recorded as part of the compressed synapse data SD_C.

In operation S950, the synapse data compressor 13 may record the size of a kernel. The size of a kernel may be recorded as part of the compressed synapse data SD_C.

For example, since the sub-sampling layer does not have synapse data, compression of the synapse data for the sub-sampling layer may not be performed.

FIG. 20 is a flowchart showing an example of a method of compressing an active layer (operation S265). Referring to FIGS. 1 to 3 and 20, in operation S1010, the synapse data compressor 13 may record the number of kernel channels.

For example, since the sub-sampling layer does not have synapse data, compression of the synapse data for the sub-sampling layer may not be performed.

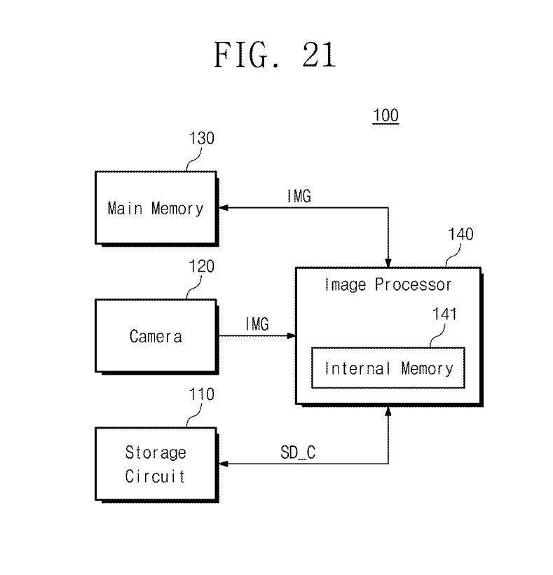

FIG. 21 is a block diagram showing an example of an image identification device 100 according to an embodiment of the inventive concept. Referring to FIGS. 1 and 21, the image identification device 100 includes a storage circuit 110, a camera 120, a main memory 130, and an image processor 140.

The storage circuit 110 may store the synapse data SD_C compressed by the synapse data compressor 13. The camera 120 may obtain the image data IMG. The image data IMG obtained by the camera 120 may be stored in the main memory 130. The main memory 130 may include at least one random access memories (RAMs) such as a dynamic RAM (DRAM), a static RAM (SRAM), a phase-change RAM, a ferroelectric RAM, a resistive RAM, a magnetic RAM, and the like.

The image processor 140 includes an internal memory 141. The image processor 140 may load the compressed synapse data SD_C from the storage circuit 110 into the internal memory 141. The internal memory 141 may be an SRAM. If the capacity of the compressed synapse data SD_C is greater than the capacity of the internal memory 141, the image processor 140 may load the compressed synapse data SD_C of the storage circuit 110 into the main memory 130. The image processor 140 may load necessary portions of the compressed synapse data SD_C loaded in the main memory 130 into the internal memory 141.

The image processor 140 may identify the image of the image data 130 stored in the main memory 130 using the compressed synapse data SD_C loaded into the internal memory 141.

The image processor 140 may include an IC, an FPGA, a CPLD, an ASIC, a circuit, a device, a GPU, a Neuromorphic chip, and the like, which are configured to generate a CNN using the compressed synapse data SD_C and identify an image according to an embodiment of inventive concept. The image processor 140 may include an IC, an FPGA, a CPLD, an ASIC, a circuit, a device, a GPU, a Neuromorphic chip, and the like, which drive firmware (or software) configured to generate a CNN using the compressed synapse data SD_C and identify an image according to an embodiment of inventive concept.

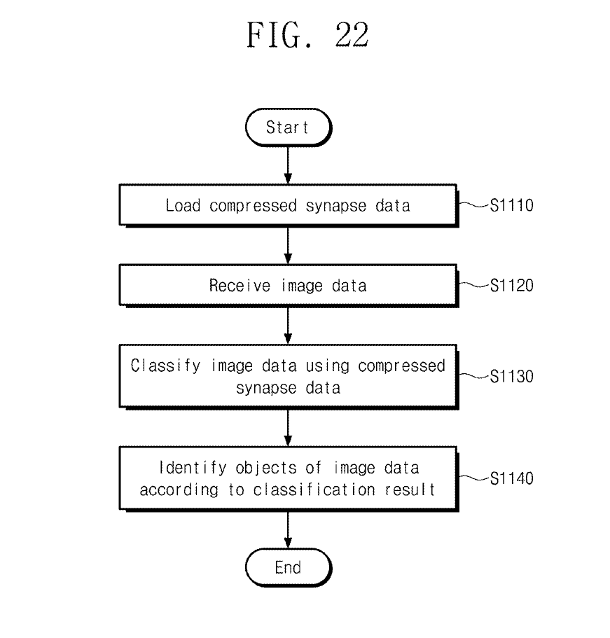

FIG. 22 is a flowchart showing an example of an operation method of the image processor 140 of FIG. 21. Referring to FIGS. 21 and 22, in operation S1110, the image processor 140 may load the compressed synapse data SD_C from the storage circuit 110 or the main memory 130.

In operation S1120, the image processor 140 may receive image data IMG from the camera 120. In operation S1130, the image processor 140 may classify the image data IMG using the compressed synapse data SD_C.

In operation S1140, the image processor 140 may identify the objects of the image data according to the classification result.

FIG. 23 is a block diagram showing an example of a convolution neural network system 20 according to an application example of the inventive concept. Referring to FIG. 23, the convolution neural network system 20 includes an image database 21, a machine learning device 22, and an image identification device 200. The image identification device 200 includes a storage circuit 210 and a synapse data compressor 242. Compared with FIG. 1, the synapse data compressor 242 is provided within the image identification device 200. The machine learning device 22 may deliver the uncompressed synapse data SD to the image identification device 200.

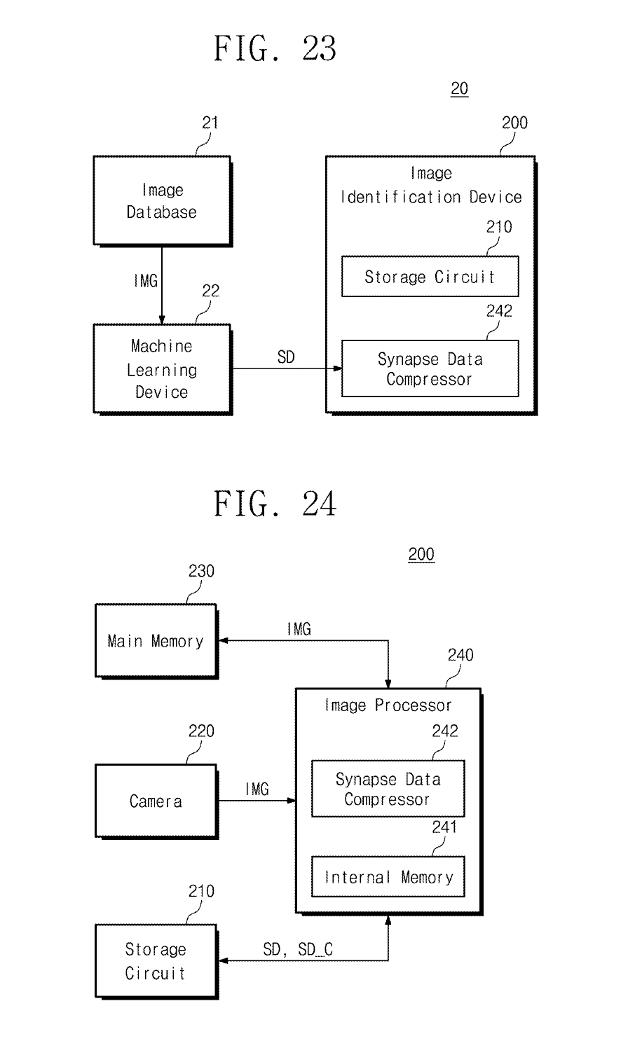

FIG. 24 is a block diagram showing an example of the image identification device 200 of FIG. 23 according to an embodiment of the inventive concept. Referring to FIGS. 23 and 24, the image identification device 200 includes a storage circuit 210, a camera 220, a main memory 230, and an image processor 200. The image processor 240 includes an internal memory 241 and a synapse data compressor 242.

The storage circuit 210 may store synapse data SD generated by the machine learning device 22. The image processor 240 may receive image data IMG from the camera 220.

For example, when image identification is needed, the image processor 240 may read the synapse data SD stored in the storage circuit 210. The synapse data compressor 242 may compress the read synapse data to generate compressed synapse data SD_C. The compressed synapse data SD_C may be stored in at least one of the storage circuit 210, the main memory 230, and the internal memory 241.

For example, the image processor 240 may read the synapse data SD from the storage circuit 210, and compress and use the read synapse data when the synapse data SD is needed. As another example, the image processor 240 may read and compress synapse data SD when the synapse data SD is stored in storage circuit 210. The image processor 240 may store the compressed synapse data SD_C in the storage circuit 210, and read and use it when necessary.

The image processor 140 may include an IC, an FPGA, a CPLD, an ASIC, a circuit, a device, a GPU, a Neuromorphic chip, and the like, which are configured to compress the synapse data SD, generate a CNN using the compressed synapse data SD_C, and identify an image according to an embodiment of inventive concept. The image processor 140 may include an IC, an FPGA, a CPLD, an ASIC, a circuit, a device, a GPU, a Neuromorphic chip, and the like, which drive firmware (or software) configured to compress the synapse data SD, generate a CNN using the compressed synapse data SD_C, and identify an image according to an embodiment of inventive concept.

According to embodiments of the inventive concept, synapse data is compressed based on sparsity. The compressed synapse data may be used to identify an image without decompression. Therefore, a convolution neural network system with reduced amount of synapse data and a method of compressing synapse data of a CNN are provided.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A convolution neural network system comprising:
an image database configured to store first image data;
a machine learning device configured to receive the first image data from the image database and generate synapse data of a convolution neural network including a plurality of layers for image identification based on the first image data;
a synapse data compressor configured to compress the synapse data based on sparsity of the synapse data; and
an image identification device configured to store the compressed synapse data and perform image identification on second image data without decompression of the compressed synapse data.

2. The convolution neural network system of claim 1, wherein the synapse data compressor varies a method of compressing synapse data corresponding to each layer according to a type of each of the plurality of layers of the convolution neural network.

3. The convolution neural network system of claim 1, wherein the synapse data compressor selects different compression methods, compresses the synapse data using the different compression methods, and selects a compressed synapse data group having a minimum capacity among compressed synapse data groups according to the different compression methods.

4. The convolution neural network system of claim 3, wherein the compression methods comprises a method of compressing the synapse data as a non-zero value in the synapse data and indexes indicating a position of the non-zero value.

5. The convolution neural network system of claim 4, wherein the synapse data compressor records each of the indexes as index bits, and divides an index exceeding a range displayed as the index bits into first index bits and second index bits and records the first and second index bits.

6. The convolution neural network system of claim 5, wherein the synapse data compressor records the first index bits as a maximum value and records the second index bits as a remaining value obtained by subtracting a value obtained by adding 1 to the maximum value from the index.

7. The convolution neural network system of claim 5, wherein the synapse data compressor records index bits of one or more indexes as one byte.

8. The convolution neural network system of claim 7, wherein when the index bits of the one or more indexes are smaller than the size of the one byte, the synapse data compressor adds one or more dummy bits to the index bits of the one or more indexes to record the index bits as the one byte.

9. The convolution neural network system of claim 3, wherein the compression methods comprise a method of compressing the synapse data as the number (i.e., the first number) of non-zero values and zero values in the synapse data.

10. The convolution neural network system of claim 9, wherein the synapse data compressor records the first number as the number (i.e., the second number) of zero and continuous zero values.

11. The convolution neural network system of claim 10, wherein the synapse data compressor records the second number as index bits, and divides the second number exceeding a range displayed as the index bits into first index bits and second index bits and records the first and second index bits.

12. The convolution neural network system of claim 11, wherein the synapse data compressor records zero and the first index bits and records zero and the second index bits,
wherein the first index bits have a maximum value and the second index bits have a value obtained by subtracting a value obtained by adding 1 to the maximum value of the first index bits from the second number.

13. A method of compressing synapse data of a convolution neural network, the method comprising:
selecting one compression method from compression methods;
selecting the number of index bits; and
performing compression of the synapse data according to the selected compression method and the selected number of index bits based on sparsity of the synapse data,
wherein the index bits are a unit of a size of one index indicting information of one synapse of the synapse data.

14. The method of claim 13, wherein information recorded for each layer varies according to a type of layers of the convolution neural network in the compressed synapse data.

15. The method of claim 13, wherein the compression methods comprise a first method of compressing the synapse data as indexes indicating a non-zero value in the synapse data and indexes indicating a position of the non-zero value and a second method of compressing the synapse data as the number of zero values in the synapse data and a non-zero value.

16. The method of claim 13, further comprising selecting a compressed synapse data group having a smallest capacity among compressed synapse data groups according to different compression methods and the number of different index bits as compressed synapse data.
